(19) United States
(12) Patent Application Publication
(10) Pub. No.: US 2024/0263998 A1
(43) Pub. Date: Aug. 8, 2024

(54) CAMERA SYSTEM

(71) Applicant: SONY SEMICONDUCTOR SOLUTIONS CORPORATION, KANAGAWA (JP)

(72) Inventor: MASAHIKO NAKAMIZO, KANAGAWA (JP)

(21) Appl. No.: 18/567,803

(22) PCT Filed: Mar. 8, 2022
(86) PCT No.: PCT/JP2022/010088

§ 371 Date: Dec. 7, 2023

(30) Foreign Application Priority Data
Jun. 16, 2021 (JP) 2021-100075

(51) Int. Cl. G01J 3/28; G01J 3/02; G01J 3/10

(52) U.S. Cl. CPC G01J 3/2823; G01J 3/021; G01J 3/027; G01J 3/10; G01J 2003/283

(57) ABSTRACT

A camera system includes: an imaging optical system including an optical element for imaging; a mirror configured to perform spectroscopy on light incident via the imaging optical system; a first imaging element configured to output first captured image data used as learning data of machine learning by receiving the incident light incident via the mirror and performing photoelectric conversion; and a second imaging element configured to output second captured image data used as the learning data by receiving the incident light incident via the mirror and performing photoelectric conversion.

### TECHNICAL FIELD

The present technology relates to a technical field of a camera system including a plurality of imaging elements.

### BACKGROUND ART

Machine learning requires a large amount of learning data to improve the performance of a learning model. Preparation of learning data may take man-hours, and it has been difficult to prepare a large amount of learning data.

Patent Document 1 below discloses a technique for improving accuracy when learning data is cut out from image data.

### CITATION LIST

### Patent Document

Patent Document 1: Japanese Patent Application Laid-Open No. 2020-046858

### SUMMARY OF THE INVENTION

### Problems to be Solved by the Invention

Meanwhile, in a case of estimating information not included in captured image data on the basis of information obtained from the captured image data, there is known a technique of preparing a plurality of types of captured image data as learning data and performing machine learning. For example, a case where depth information (distance information) about a subject is estimated on the basis of two-dimensional color image data will be described as an example. At this time, optimum learning data used for machine learning is color image data and distance image data captured after matching various conditions such as an angle of view and a distance.

However, it is difficult to obtain different types of captured image data while matching various conditions. Therefore, it is general to construct a learning model by using a plurality of types of captured image data obtained in a similar imaging environment, that is, color image data and distance image data as learning data and use the learning model for inference.

Furthermore, there is also a method of constructing a learning model by preparing learning data by artificially creating other types of captured image data on the basis of one type of captured image data actually captured or artificially creating all the captured image data.

In a case where such a method is used, the performance of the learning model is not necessarily high in some cases.

The present technology has been made in view of such a problem, and an object thereof is to provide a camera system capable of acquiring a plurality of types of captured image data appropriate as learning data used for machine learning.

### Solutions to Problems

A camera system according to the present technology includes: an imaging optical system including an optical element for imaging; a mirror configured to perform spectroscopy on light incident via the imaging optical system; a first imaging element configured to output first captured image data used as learning data of machine learning by receiving incident light incident via the mirror and performing photoelectric conversion; and a second imaging element configured to output second captured image data used as the learning data by receiving incident light incident via the mirror and performing photoelectric conversion.

With this configuration, the light incident on the first imaging element and the second imaging element is light that has passed through the same imaging optical system.

### BRIEF DESCRIPTION OF DRAWINGS

FIG. 1 is a diagram illustrating a configuration example of a camera system according to a first embodiment.

FIG. 2 is a diagram illustrating a state in which a movable mirror is located at a second position in the camera system according to the first embodiment.

FIG. 3 is a timing chart of control of a movable mirror, an imaging operation of a first imaging element, and an imaging operation of a second imaging element according to the first embodiment.

FIG. 4 is another example of a timing chart of the control of the movable mirror, the imaging operation of the first imaging element, and the imaging operation of the second imaging element according to the first embodiment.

FIG. 5 is a diagram illustrating a configuration example of a camera system according to a second embodiment.

FIG. 6 is an example of a timing chart of control of a movable mirror, control of a light emitting unit, an imaging operation of a first imaging element, and an imaging operation of a second imaging element according to the second embodiment.

FIG. 7 is another example of a timing chart of the control of the movable mirror, the control of the light emitting unit, the imaging operation of the first imaging element, and the imaging operation of the second imaging element according to the second embodiment.

FIG. 8 is a diagram illustrating a configuration example of a camera system according to a third embodiment.

FIG. 9 is an example of a timing chart of control of a half mirror, an imaging operation of a first imaging element, and an imaging operation of a second imaging element according to the third embodiment.

FIG. 10 is a diagram illustrating another example of the configuration of the camera system according to the third embodiment.

FIG. 11 is an example of a timing chart of the control of the half mirror, control of a light emitting unit, the imaging operation of the first imaging element, and the imaging operation of the second imaging element according to the third embodiment.

FIG. 12 is a diagram illustrating a configuration example of a camera system according to a modification.

FIG. 13 is a diagram illustrating another example of the configuration of the camera system according to the modification.

FIG. 14 is a diagram illustrating still another example of the configuration of the camera system according to the modification.

FIG. 15 is a diagram illustrating still another example of the configuration of the camera system according to the modification.

FIG. 16 is a block diagram illustrating a configuration of an entire system including a providing system.

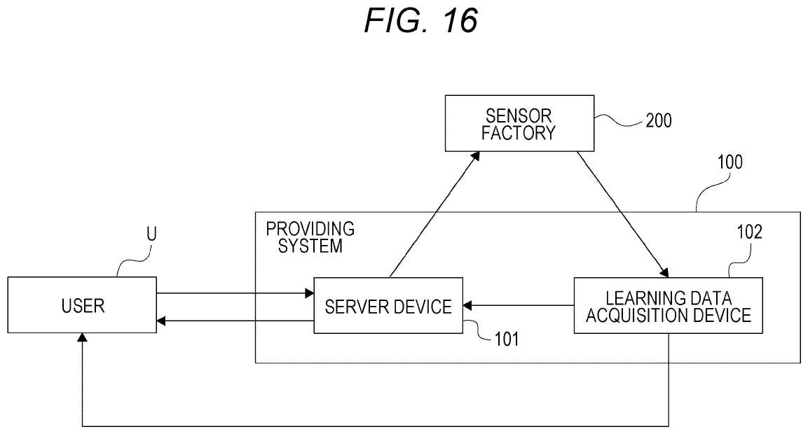

FIG. 17 is a flowchart of processing executed by the providing system.

FIG. 18 is a block diagram illustrating another example of the configuration of the entire system including the providing system.

FIG. 19 is a block diagram of a computer device.

### MODE FOR CARRYING OUT THE INVENTION

Hereinafter, embodiments according to the present technology will be described in the following order with reference to the accompanying drawings.
<1. Plurality of types of captured image data>
<2. First Embodiment>
<2-1. Configuration example of camera system>
<2-2. Timing chart>
<3. Second Embodiment>
<4. Third Embodiment>
<5. Modification of configuration of camera system>
<6. Summary of camera system>
<7. Providing system>
<8. Computer device>
<9. Summary of providing system>
<10. Present technology>

### 1. Plurality of Types of Captured Image Data

A camera system 1 according to the present embodiment is a camera system 1 that generates a plurality of types of captured image data substantially simultaneously. Furthermore, the plurality of types of captured image data is obtained by capturing under the same condition as much as possible.

The plurality of types of captured image data is provided to machine learning as a set of captured image data captured under substantially the same condition and at substantially the same timing.

By performing machine learning using different types of captured image data as input data, it is possible to construct a learning model for estimating another piece of captured image data on the basis of one piece of captured image data.

By using the learned learning model, it is possible to infer another piece of captured image data from one piece of captured image data. Furthermore, this also leads to improvement of various algorithms.

Specifically, two types of color image data and distance image data will be described as an example. In the camera system 1 according to the present embodiment, color image data and distance image data are generated by imaging the same subject at substantially the same timing in a state where various conditions such as an angle of view are matched. The color image data and the distance image data can be said to be corresponding image data.

For example, in the color image data and the distance image data obtained by matching various conditions such as the number of pixels, an angle of view, and an imaging magnification, color information and distance information at a certain pixel position completely correspond to each other.

The two types of captured image data obtained in such a manner are used as learning data to generate a learning model. With this learning model, for example, by performing inference on color image data for which the corresponding distance image data cannot be obtained, the corresponding distance image data can be generated.

Therefore, for example, the distance can be estimated for each subject captured in the color image data.

In such a manner, by combining a plurality of types of captured image data, it is possible to generate a learning model for inferring another piece of captured image data from one piece of captured image data.

Furthermore, by performing machine learning using learning data obtained by continuously acquiring two types of captured image data at a plurality of times, it is possible to generate a learning model capable of performing highly accurate inference.

Here, the type of the captured image data will be described.

Various types of captured image data are conceivable according to the configuration and characteristics of the imaging element.

Examples thereof include color image data and monochrome image data.

By performing machine learning using these captured image data, it is possible to estimate color image data from monochrome image data and improve a conversion algorithm.

Furthermore, the color image data and the monochrome image data include captured image data with high resolution and captured image data with low resolution according to the difference in the number of pixels.

By performing machine learning using captured image data having different numbers of pixels, it is possible to estimate captured image data with high resolution from captured image data with low resolution and improve a conversion algorithm.

Furthermore, the plurality of types of captured image data also includes distance image data as depth information of the subject and polarized image data as polarization information of the subject for each pixel.

By performing machine learning using these captured image data, it is possible to estimate distance image data from color image data, estimate polarized image data from color image data, and the like.

Moreover, the color image data is different types of captured image data according to the type of a color filter. Specifically, various types of RGB captured image data obtained from an imaging element in which primary color filters of red (R), green (G), and blue (B) are arranged in a predetermined pattern such as a Bayer array, RCCB captured image data obtained from an imaging element in which color filters corresponding to red (R), clear (C), and blue (B) are arranged in a predetermined pattern, CMY captured image data obtained from an imaging element in which complementary color filters corresponding to cyan (Cy), yellow (Ye), green (G), and magenta (Mg) are arranged in a predetermined pattern, and the like can be considered.

Characteristics of captured image data obtained are different according to the type of a color filter. Specifically, there are an array of color filters excellent in color reproduction, an array of color filters excellent in resolution, and the like. Then, by performing machine learning using a plurality of pieces of captured image data obtained by the imaging element in which the color filters are arranged in different modes, captured image data having both characteristics can be inferred.

Furthermore, the color image data obtained in the imaging element in which a plurality of types of color filters is arrayed in a predetermined pattern as described above requires demosaic processing. On the other hand, by using an imaging element having a structure in which a plurality of absorbing layers is stacked in one pixel, a plurality of types of color signals (for example, an R signal, a G signal, and a B signal) can be obtained from one pixel. If such an imaging element is used, demosaic processing becomes unnecessary.

Then, by performing machine learning using these captured image data as learning data, it is possible to improve the demosaic processing algorithm. In other words, the captured image data obtained by the demosaic processing can be brought close to the captured image data generated by obtaining a plurality of color signals from one pixel. As a result, it is possible to reduce deterioration in image quality and the like due to the demosaic processing.

Alternatively, infrared (IR) captured image data obtained from an imaging element including an IR filter having sensitivity to IR light may be used. By performing machine learning using these pieces of data, for example, it is possible to infer IR captured image data from color image data.

Furthermore, captured image data obtained by an imaging element including a phase difference pixel is also considered. Such captured image data is paired with captured image data obtained by an imaging element not including a phase difference pixel.

That is, in a case where the phase difference pixel is included, defective pixel complementing processing is required to obtain an appropriate pixel signal for the phase difference pixel regarded as a defective pixel.

Then, by performing machine learning using the captured image data captured including the phase difference pixel and the captured image data captured without including the phase difference pixel, it is possible to improve the performance of the algorithm of the defective pixel complementing processing.

In addition, by performing machine learning using the color image data obtained in the configuration in which the occurrence probability of crosstalk is reduced and the color image data obtained in the configuration in which light receiving sensitivity is improved, it is possible to obtain good captured image data in which noise based on crosstalk and a decrease in light receiving sensitivity is reduced.

### 2. First Embodiment

### 2-1. Configuration Example of Camera System

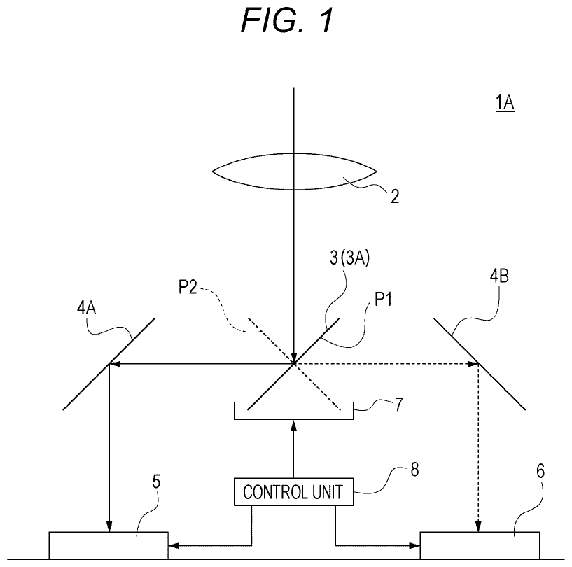

The camera system 1 for obtaining a plurality of types of captured image data under substantially the same condition will be described. Specifically, regarding a configuration of a camera system 1A according to a first embodiment, the first embodiment will be described with reference to FIG. 1.

The camera system 1A includes an imaging optical system 2, a first mirror 3, second mirrors 4A and 4B, a first imaging element 5, a second imaging element 6, a mirror movable part 7, and a control unit 8.

The imaging optical system 2 includes various types of lenses such as a focus lens and a zoom lens, an iris mechanism, a mechanical shutter mechanism, and the like. Note that the mechanical shutter mechanism may not be included by performing the electronic shutter control.

The first mirror 3 is a movable mirror 3A movable between a first position P1 and a second position P2. In a state where the movable mirror 3A is located at the first position P1, incident light (subject light) having passed through the imaging optical system 2 is reflected toward the second mirror 4A.

In the second mirror 4A, the incident subject light is further reflected toward the first imaging element 5.

The first imaging element 5 includes a color filter, a microlens, a light receiving element, a reading circuit, and the like, and outputs first captured image data. The first imaging element 5 receives subject light in a state where the movable mirror 3A is located at the first position P1, and accumulates charges by photoelectric conversion.

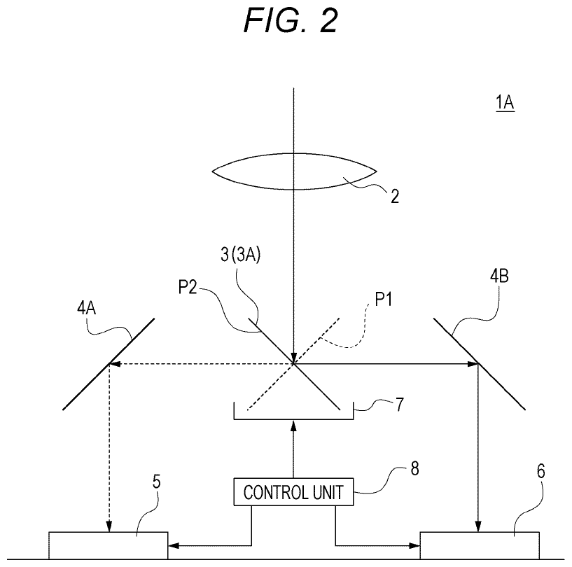

In a state where the movable mirror 3A is located at the second position P2 (refer to FIG. 2), subject light having passed through the imaging optical system 2 is reflected toward the second mirror 4B.

In the second mirror 4B, the incident subject light is further reflected toward the second imaging element 6.

The second imaging element 6 includes a color filter, a microlens, a light receiving element, a reading circuit, and the like, and outputs second captured image data.

However, some configuration is changed with respect to the first imaging element 5. For example, in a case where the first captured image data is color image data and the second captured image data is monochrome image data, the second imaging element 6 does not include a color filter.

Alternatively, in a case where the second captured image data is polarized image data, the second imaging element 6 includes a polarizer.

In addition, the first imaging element 5 and the second imaging element 6 may include optical filters having different optical characteristics. For example, the first imaging element 5 may include a primary color filter, and the second imaging element 6 may include a complementary color filter.

With these optical filters, a plurality of pieces of captured image data can be obtained.

Furthermore, the first imaging element 5 may not include the phase difference pixel, and the second imaging element 6 may include the phase difference pixel.

Furthermore, while the first imaging element 5 is configured such that each pixel has sensitivity for one wavelength band by including only one color filter of one color, the second imaging element 6 may be configured such that each pixel has sensitivity for a plurality of wavelength bands.

Furthermore, the first imaging element 5 may be configured such that the frequency of occurrence of optical crosstalk is low, and the second imaging element 6 may be configured such that light receiving sensitivity is high.

The number of pixels of the first imaging element 5 and the number of pixels of the second imaging element 6 may be the same or different. For example, in a case where there is a difference other than the number of pixels in the configuration between the first imaging element 5 and the second imaging element 6, it is desirable that the number of pixels of the first imaging element 5 and the number of pixels of the second imaging element 6 be the same. The captured image data obtained as a result includes only a difference caused by a difference in the configuration other than the resolution.

On the other hand, in a case where the number of pixels of the first imaging element 5 and the number of pixels of the second imaging element 6 are different, it is desirable that conditions other than the number of pixels of the first imaging element 5 and the number of pixels of the second imaging element 6 be the same as much as possible. The captured image data obtained as a result includes only a difference caused by a difference in resolution.

The second imaging element 6 receives subject light in a state where the movable mirror 3A is located at the second position P2, and accumulates charges by photoelectric conversion.

Considering the exposure time required to obtain one piece of captured image data, the switching period of the movable mirror 3A is a short time such as several milliseconds or several tens of milliseconds. Therefore, the first captured image data and the second captured image data can be regarded as data captured at substantially the same timing.

In particular, in a case where the subject is not a moving subject, it is possible to obtain data comparable to captured image data obtained in a case where the first imaging element 5 and the second imaging element 6 images the subject at exactly the same timing.

The mirror movable part 7 has a mechanism that moves the movable mirror 3A. Note that the mirror movable part 7 may be provided integrally with the mirror 3A.

The control unit 8 performs overall control of the camera system 1A, drive control of the imaging optical system 2, and drive control of the mirror movable part 7. With this drive control, the control unit 8 controls the position of the movable mirror 3A.

The control unit 8 performs the drive control of the movable mirror 3A, so that time-division spectroscopy is performed in the movable mirror 3A.

### 2-2. Timing Chart

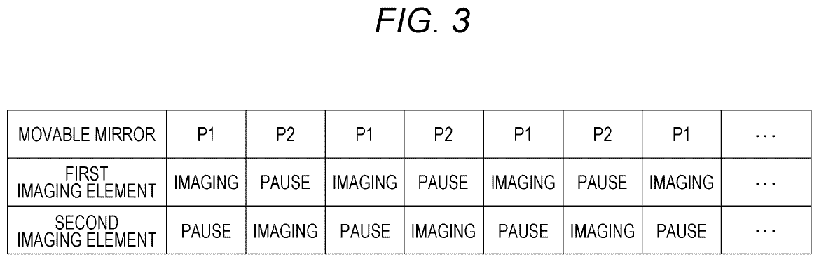

The control of the movable mirror 3A performed by the control unit 8 is performed in synchronization with the imaging operations of the first imaging element 5 and the second imaging element 6. FIG. 3 illustrates a timing chart of the imaging operation of each imaging element and the operation of the movable mirror 3A.

In a case where the movable mirror 3A is located at the first position P1, the imaging operation is performed in the first imaging element 5, and the imaging operation is paused in the second imaging element 6.

In response to the control unit 8 moving the position of the movable mirror 3A from the first position P1 to the second position P2, the imaging operation is paused in the first imaging element 5, and the imaging operation is performed in the second imaging element 6.

In a case where the position of the movable mirror 3A is switched between the first position P1 and the second position P2 at 1/60 sec intervals, the imaging operation and the pause operation of each imaging element are switched at 1/60 sec intervals. As a result, one piece of captured image data is output from each imaging element at 1/30 sec intervals.

Note that while the movable mirror 3A moves from the first position P1 to the second position P2 or from the second position P2 to the first position P1, there is a possibility that the light incident on each imaging element contains a large amount of noise.

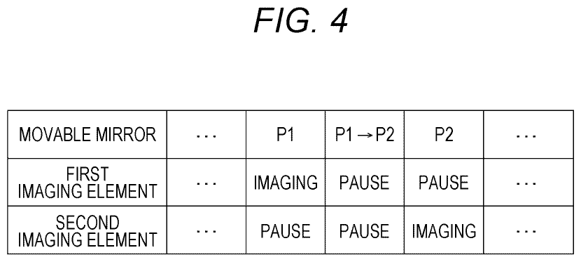

In that case, as illustrated in FIG. 4, the imaging operation may be paused in both the first imaging element 5 and the second imaging element 6 during the time during which the movable mirror 3A moves from the first position P1 to the second position P2.

The same applies to the time during which the movable mirror 3A moves from the second position P2 to the first position P1.

### 3. Second Embodiment

In a camera system 1B according to a second embodiment, distance image data is generated in the second imaging element 6.

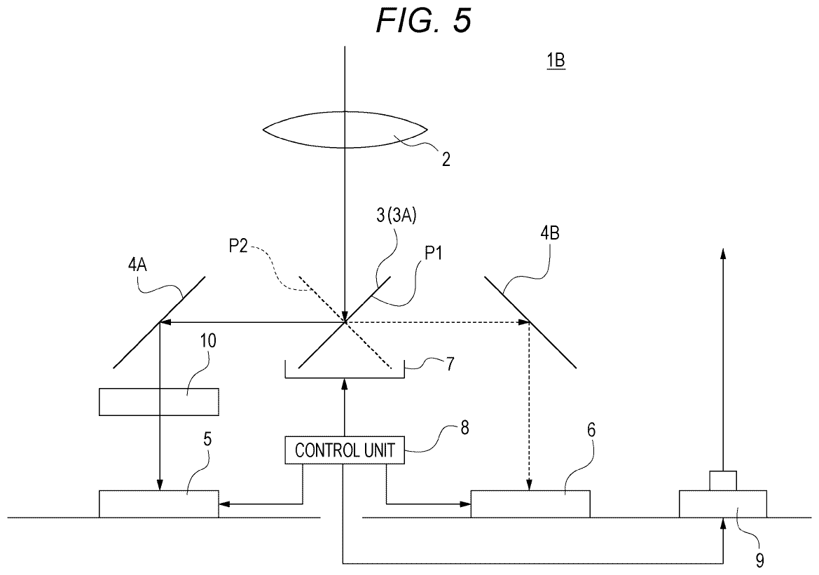

Specifically, a configuration of the camera system 1B will be described with reference to FIG. 5.

The camera system 1B includes a light emitting unit 9.

The light emitting unit 9 includes a driver circuit and emits IR light toward a subject. Irradiation control of the IR light from the light emitting unit 9 is performed by the control unit 8.

An IR cut filter 10 that blocks the IR light is provided at a preceding stage of the first imaging element 5. The IR cut filter 10 may be provided as a part of the first imaging element 5.

Various types of light emitting modes of the light emitting unit 9 can be considered. For example, in addition to simply emitting and quenching the IR light, the IR light may be emitted so as to project a stripe-shaped or lattice-shaped light emission pattern on the subject.

The second imaging element 6 is a time of flight (ToF) sensor that performs distance measurement by a ToF method. The ToF may be either direct ToF (dToF) or indirect ToF (iToF).

As a result, distance image data for estimating the three-dimensional structure of the subject can be obtained.

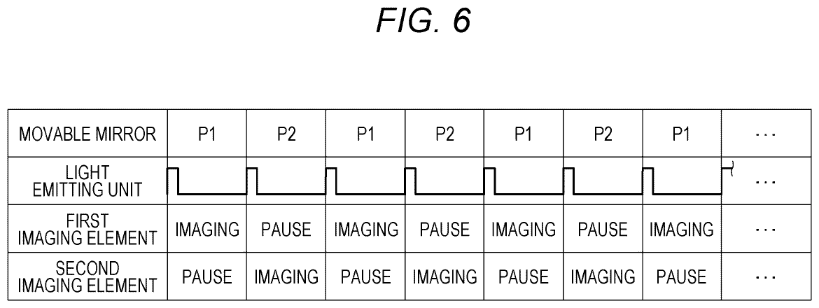

The relationship between the light emission timing of the light emitting unit 9 and the imaging timing of each imaging element is illustrated in a timing chart of FIG. 6.

As illustrated in the drawing, a light emission operation in a short time is performed at the timing when the movable mirror 3A is moved to the first position P1, and a light emission operation in a short time is also performed at the timing when the movable mirror 3A is moved to the second position P2. That is, the control unit 8 causes the light emitting unit 9 to emit light in synchronization with the movement control of the movable mirror 3A.

Note that the IR light emitted from the light emitting unit 9 in a state where the movable mirror 3A is located at the first position P1 is about to enter the first imaging element 5 via the imaging optical system 2 and the movable mirror 3A before the movable mirror 3A reflected by the subject moves to the second position P2.

However, since the IR cut filter 10 is disposed in the preceding stage of the first imaging element 5, the IR light does not reach the first imaging element 5.

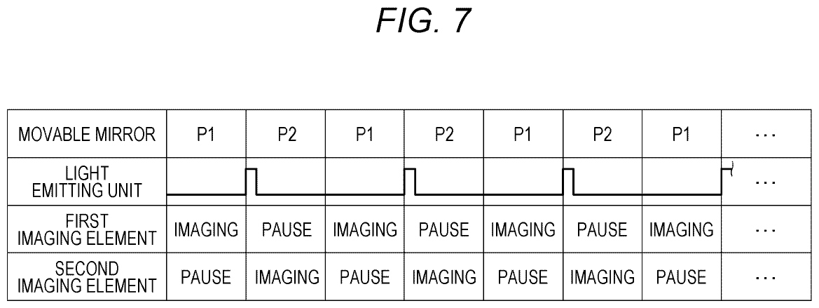

In view of this, the control unit 8 may perform the light emitting operation of the light emitting unit 9 according to the timing at which the movable mirror 3A is located at the second position P2, that is, in synchronization with the imaging operation of the second imaging element 6 (refer to FIG. 7).

### 4. Third Embodiment

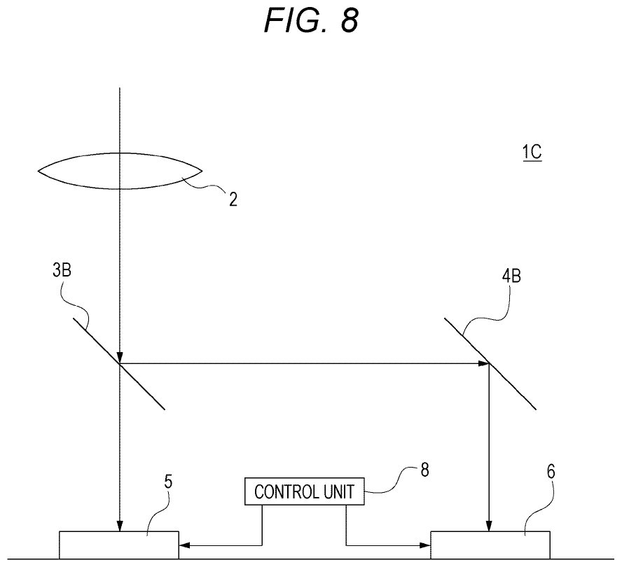

As illustrated in FIG. 8, a camera system 1C according to a third embodiment includes a half mirror 3B instead of the movable mirror 3A as the first mirror 3.

The camera system 1C includes the imaging optical system 2, a half mirror 3B, the second mirrors 4B, the first imaging element 5, the second imaging element 6, and the control unit 8.

The half mirror 3B transmits (straightens) part of light and reflects part of light. That is, the half mirror 3B performs simultaneous spectroscopy of the subject light.

The light transmitted through the half mirror 3B is incident on the first imaging element 5. On the other hand, the light reflected by the half mirror 3B is further reflected by the second mirror 4B and is incident on the second imaging element 6.

For example, the half mirror 3B is configured such that the transmitted light and the reflected light have substantially the same light amount. Alternatively, the amount of transmitted light may be made smaller than the amount of reflected light in consideration of the attenuation amount in the reflection on the second mirror 4B.

By using the half mirror 3B instead of the movable mirror 3A, the subject light is simultaneously received by the first imaging element 5 and the second imaging element 6. Therefore, it is possible to eliminate the shift of the imaging operation between the first imaging element 5 and the second imaging element 6 caused when the movable mirror 3A is used. In particular, this is effective in a case where the subject is a moving subject.

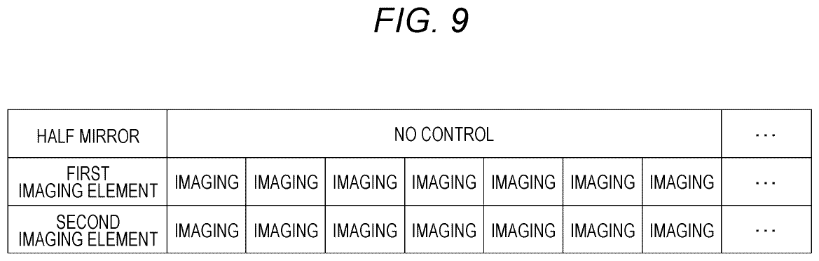

FIG. 9 illustrates a relationship between imaging timings of the respective imaging elements included in the camera system 1C in the third embodiment.

As illustrated in the drawing, the control of the half mirror 3B may not be performed. Furthermore, since there is no pause period, the imaging operation in the first imaging element 5 and the imaging operation in the second imaging element 6 can be performed at high speed.

Another example according to the third embodiment will be described.

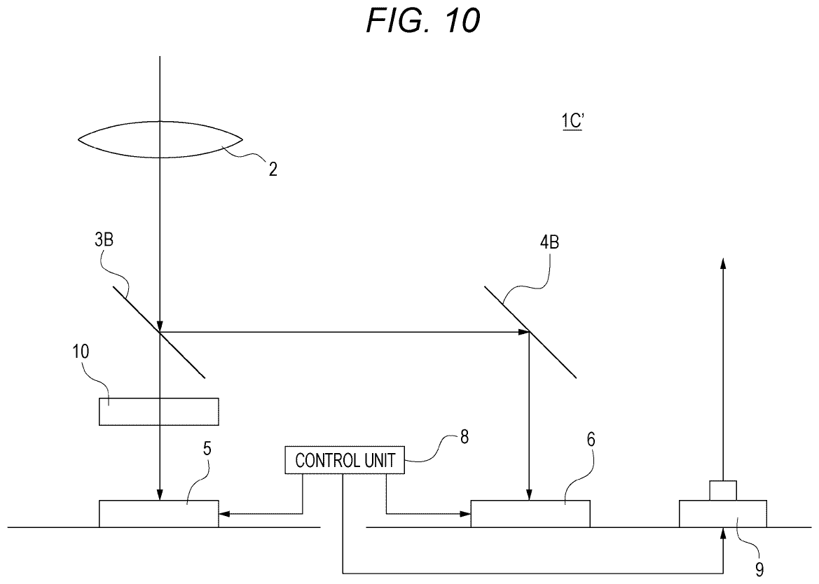

A camera system 1C′ in another example includes a half mirror 3B, a light emitting unit 9, and an IR cut filter 10 (refer to FIG. 10).

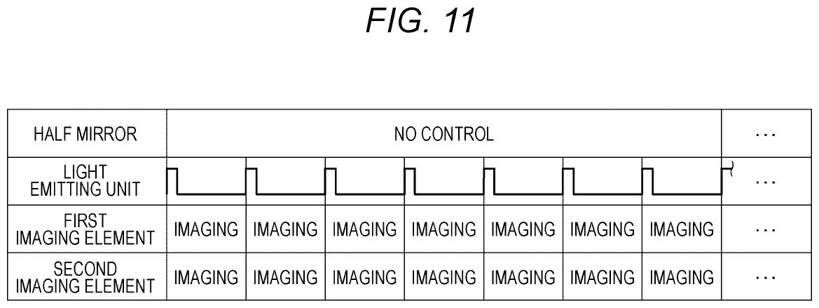

The relationship between the light emission timing of the light emitting unit 9 included in the camera system 1C′ and the imaging timing of each imaging element is illustrated in a timing chart of FIG. 11.

As illustrated in the drawing, the control of the half mirror 3B may not be performed. Furthermore, as the light emission timing of the light emitting unit 9, the light emission operation in a short time is performed in synchronization with the start of the imaging operation of the first imaging element 5 and the start of the imaging operation of the second imaging element 6.

### 5. Modification of Configuration of Camera System

In each example described above, an example in which the first imaging element 5 and the second imaging element 6 are provided on the same plane is described, but the first imaging element 5 and the second imaging element 6 may not be provided on the same plane.

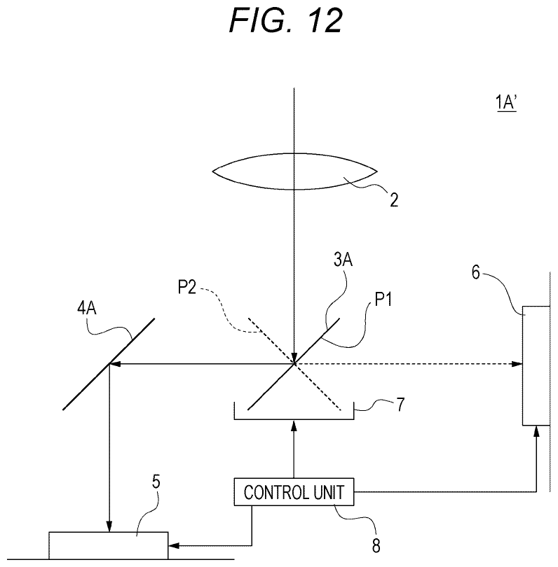

For example, as illustrated in FIG. 12, the camera system 1A′ includes the movable mirror 3A. In a state where the movable mirror 3A is controlled to the first position P1, subject light is guided to the first imaging element 5 via reflection on the second mirror 4A as in the first embodiment. On the other hand, in a state where the movable mirror 3A is controlled to the second position P2, unlike the first embodiment, subject light as reflected light by the movable mirror 3A is incident on the second imaging element 6 without the reflection on the second mirror 4B.

However, the subject light incident on the second imaging element 6 with respect to the subject light incident on the first imaging element 5 is horizontally inverted due to a difference in the number of reflections.

Therefore, it is necessary to perform a horizontal inversion processing in a subsequent process on the signal output from the second imaging element 6.

By adopting such a configuration, it is possible to reduce the number of optical members such as the second mirror 4B, so that it is possible to reduce the number of assembling steps, the number of parts, the cost, and the size of the camera system 1A′.

As described above, the configuration in which one of the second mirrors 4A and 4B is omitted can be applied not only to the camera system 1 including the movable mirror 3A but also to the camera system including the half mirror 3B.

Furthermore, both the second mirrors 4A and 4B may be omitted. In this case, the horizontal inversion processing on both the signal output from the first imaging element 5 and the signal output from the second imaging element 6 is executed in a subsequent process.

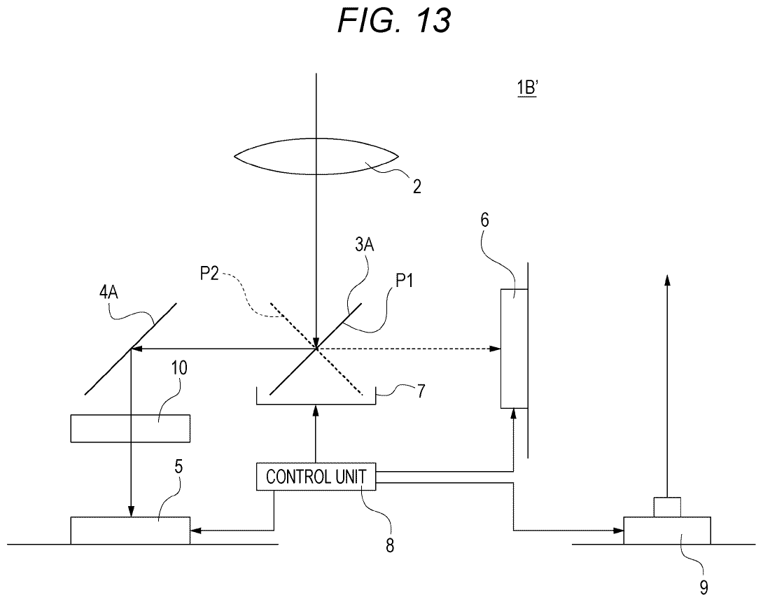

Moreover, as in a camera system 1B′ illustrated in FIG. 13, the first imaging element 5 and the second imaging element 6 may not be provided on the same plane in the configuration including the light emitting unit 9 and the IR cut filter 10.

Furthermore, a configuration in which the second mirror 4A is further reduced from the configuration illustrated in FIG. 13 may be adopted.

In any case, the horizontal inversion processing is appropriately required for the signals output from the first imaging element 5 and the second imaging element 6.

In each of the above-described examples including the light emitting unit 9, which emits IR light, the configuration including the IR cut filter 10 is described as an example, but other configurations may be adopted.

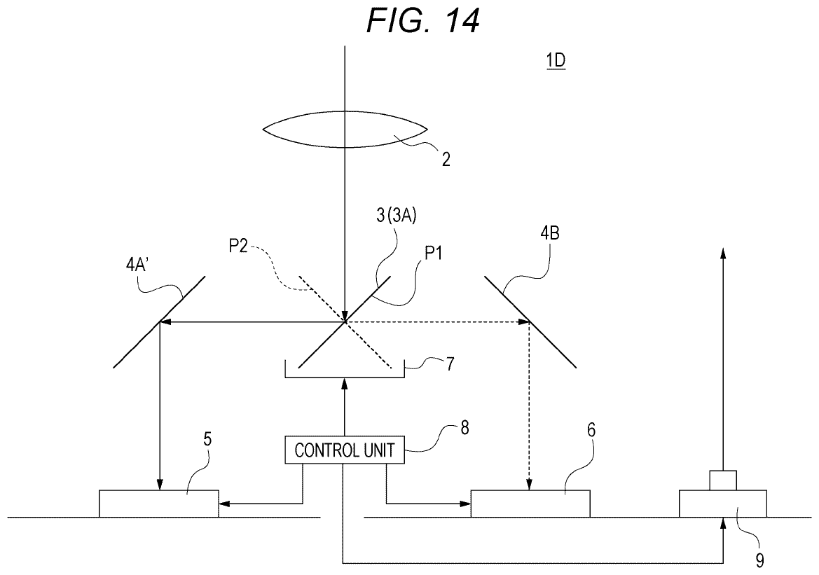

For example, as illustrated in FIG. 14, a camera system 1D may employ a dielectric mirror 4A′ as the second mirror 4A.

The dielectric mirror 4A′ has a characteristic of reflecting only visible light having a wavelength range of about 360 nm to about 830 nm or IR light having a wavelength close to visible light. Therefore, in a case where the first imaging element 5 outputs color image data, a configuration not including the IR cut filter 10 as illustrated in FIG. 14 can be adopted.

In a case where the dielectric mirror 4A′ is adopted as the second mirror 4A, it is not necessary to provide the IR cut filter 10, and thus, it is possible to reduce the number of parts, reduce the number of assembling steps, or miniaturize the camera system 1D.

In each example described above, the configuration including the two imaging elements is described, but three or more imaging elements may be included.

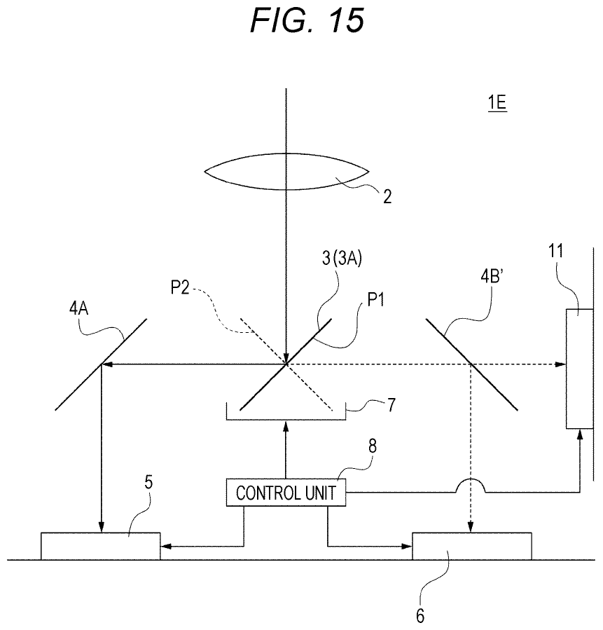

For example, a camera system 1E illustrated in FIG. 15 includes a movable mirror 3A as the first mirror 3, a second mirror 4A, and a second mirror 4B′.

The second mirror 4A has a configuration similar to that of the first embodiment. On the other hand, the second mirror 4B′ is a half mirror, and guides the reflected light to the second imaging element 6 and guides the passing light to a third imaging element 11.

With this configuration, in a state where the movable mirror 3A is controlled to the first position P1, an imaging operation is performed in the first imaging element 5. Furthermore, in a state where the movable mirror 3A is controlled to the second position P2, the imaging operation is performed in both the second imaging element 6 and the third imaging element 11.

Therefore, in the camera system 1E illustrated in FIG. 15, it is possible to obtain three pieces of captured image data substantially simultaneously.

Note that, in the configuration illustrated in FIG. 15, by adopting the half mirror as the second mirror 4A, four pieces of captured image data can be obtained substantially simultaneously.

Although the configuration of the camera system 1 is described with reference to the drawings, the camera system 1 may include a rear monitor or the like in a case where a monitor or the like for checking captured image data at the time of imaging is required. In that case, the control unit 8 generates display image data to be displayed on the rear monitor, and provides the display image data to the rear monitor via the monitor driver.

Note that a monitor provided outside the camera system 1 may be used instead of the rear monitor.

### 6. Summary of Camera System

As described using each example described above, the camera system 1 (1A, 1A′, 1B, 1B′, 1C, 1C′, 1D, 1E) includes: the imaging optical system 2 including the optical element (the lens, the iris, or the like) for imaging; the mirror (the first mirror 3 such as the movable mirror 3A or the half mirror 3B) configured to perform spectroscopy on light (subject light) incident through the imaging optical system 2; the first imaging element 5 configured to output first captured image data used as learning data of machine learning by receiving the incident light (subject light) incident through the mirror and performing photoelectric conversion; and the second imaging element 6 configured to output second captured image data used as learning data by receiving the incident light incident through the mirror and performing photoelectric conversion.

With this configuration, light incident on the first imaging element 5 and the second imaging element 6 is light that has passed through the same imaging optical system 2.

Therefore, since the difference in the imaging optical system can be eliminated from the factor of the difference between the first captured image data and the second captured image data, appropriate learning data for estimating another captured image data from one captured image data can be obtained. Then, by performing machine learning using these captured image data as the learning data, it is possible to improve the accuracy of the learning model.

In particular, by making the imaging optical system 2 common between the first imaging element 5 and the second imaging element 6, various conditions regarding imaging as an angle of view, a distance to the subject, and an imaging direction can be perfectly matched between both imaging elements, which is preferable.

As described in the first embodiment and the like, the spectroscopy in the mirror (movable mirror 3A) may be time-division spectroscopy.

For example, it is possible to increase the reflectance of the mirror, to guide the spectrum (reflected light) to the first imaging element 5 over the exposure time required for generating the first captured image data, and to guide the spectrum to the second imaging element 6 over the exposure time required for generating the second captured image data.

With this spectroscopy, the amount of light received by the first imaging element 5 and the second imaging element 6 can be secured. Therefore, it is possible to obtain the first captured image data and the second captured image data in which an increase in noise due to gain control or the like is reduced.

As described in the first embodiment and the like, the mirror movable part 7 that moves the mirror between the first position P1 in which the reflected light on the mirror (movable mirror 3A) is guided to the first imaging element 5 and the second position P2 in which the reflected light is guided to the second imaging element 6 may be included.

The camera system 1 has a configuration for moving the mirror, and can guide incident light (subject light) to each of the first imaging element 5 and the second imaging element 6 according to a movable position. As a result, imaging by the first imaging element 5 and the second imaging element 6 is performed in a time division manner.

Therefore, for example, a configuration in which the first captured image data and the second captured image data are alternately output for each frame can be adopted, and two types of image data captured at substantially the same timing can be obtained.

As described in the third embodiment and the like, the mirror (the first mirror 3) may be the half mirror 3B, the spectroscopy may be simultaneous spectroscopy by the half mirror 3B, and reflected light on the half mirror 3B may be incident on one imaging element of the first imaging element 5 and the second imaging element 6, and transmitted light on the half mirror 3B is incident on another imaging element.

The reflected light and the transmitted light are incident on the respective imaging elements using the half mirror 3B, so that exposure in the first imaging element 5 and exposure in the second imaging element 6 can be simultaneously performed.

Therefore, in a case where the subject to be imaged is a moving subject with motion, the imaging position of the subject is prevented from being different for each imaging element due to the motion of the subject. As a result, it is possible to generate optimum data as learning data used for machine learning.

As described in each example described above, the first captured image data may be color image data.

Various types of captured image data are conceivable, but in general, color image data is widely used. In the present configuration, the first captured image data as color image data and the second captured image data as other image data such as distance image data and IR image data can be acquired.

As a result, it is possible to generate learning data for acquiring a learning model used for estimating other image data from color image data, which is generally widely used.

As described in the second embodiment and the like, the second captured image data may be distance image data.

As a result, it is possible to generate learning data for generating a learning model for estimating distance image data from color image data.

Therefore, by performing inference processing using the learning model obtained in such a manner, the distance information to each imaged subject can be obtained from the color image data. By using the distance information obtained in such a manner, for example, it is possible to construct a three-dimensional model from two-dimensional color image data.

As described in the second embodiment and the like, the light emitting unit 9, which is controlled to emit light in synchronization with the imaging operation of the second imaging element 6, may be included.

As a result, the second imaging element 6 can perform exposure control according to the timing of receiving the reflected light (subject light) emitted from the light emitting unit 9 and reflected by the subject.

Therefore, the second imaging element 6 can generate distance image data based on the distance to the subject.

As described in the first embodiment and the like, the second captured image data may be polarized image data.

As a result, the polarized image data corresponding to the color image data is output from the camera system.

Therefore, it is possible to generate learning data for generating a learning model for estimating the orientation of the face or the like for each subject on the basis of the color image data. The orientation of the face for each subject obtained by the inference processing using such a learning model can be used, for example, when a three-dimensional model is constructed from two-dimensional image data.

As described in the first embodiment and the like, the optical filter included in the first imaging element 5 and the optical filter included in the second imaging element 6 may have different optical characteristics.

As a result, it is possible to obtain captured image data obtained in an imaging element having different optical characteristics corresponding to captured image data obtained in an imaging element having certain optical characteristics.

Therefore, on the basis of captured image data obtained in an imaging element having one optical characteristic, learning data for inferring captured image data that will be obtained in another imaging element can be obtained.

The difference in optical characteristics is, for example, a difference in characteristics of light receiving sensitivity with respect to an optical wavelength.

As described in the first embodiment, the first imaging element 5 may include a primary color filter, and the second imaging element 6 may include a complementary color filter.

In general, captured image data obtained in an imaging element using a primary color filter tends to have good color reproduction and signal to noise (SN) ratio, and captured image data obtained in an imaging element using a complementary color filter tends to have good light receiving sensitivity and resolution.

According to the present configuration, the second captured image data obtained by the complementary color filter can be generated as the captured image data corresponding to the first captured image data obtained by the primary color filter.

Therefore, it is possible to generate a learning model for estimating the second captured image data obtained by the complementary color filter from the first captured image data obtained by the primary color filter. By using such a learning model, in a case where an image corresponding to the first captured image data is captured, the corresponding second captured image data can be obtained by inference processing. Then, it is possible to generate a new image having both good characteristics of color reproduction and an SN ratio obtained using the primary color filter and good characteristics such as high light receiving sensitivity and high resolution obtained using the complementary color filter.

As described in the first embodiment, the second captured image data may be monochrome image data.

As a result, the monochrome image data corresponding to the color image data is output from the camera system.

Therefore, it is possible to generate learning data for generating a learning model for estimating color image data on the basis of the monochrome image data. By performing inference processing using such a learning model, for example, even in a case where there is only monochrome image data, color image data can be generated. That is, it is possible to reproduce the color at the time from monochrome image data captured in a time when color captured image data cannot be obtained.

As described in the first embodiment, the first imaging element 5 may have a pixel configuration not including a phase difference pixel, and the second imaging element 6 may have a pixel configuration including a phase difference pixel.

The phase difference pixel included in the second imaging element 6 may not be able to output a pixel signal used for captured image data. In such a case, the phase difference pixel is treated as a pixel defect when viewed from the captured image data. Then, defective pixel complementation (correction) using pixel signals output from the peripheral pixels is performed to estimate pixel signals to be output from the phase difference pixels.

According to the present configuration, it is possible to output both the first captured image data in a state in which the defective pixel complementation has not been performed and the second captured image data in a state in which the defective pixel complementation has been performed.

With this configuration, it is possible to output the learning data to be used for the learning model for estimating the captured image data to which the defective pixel complementation has not been performed from the captured image data to which the defective pixel complementation has been performed. Therefore, in a case where only the captured image data by the imaging element including the phase difference pixel can be obtained, the captured image data by the imaging element not including the phase difference pixel can be estimated. Furthermore, since the first imaging element 5 does not include the phase difference pixel, the first captured image data output from the first imaging element 5 can be regarded as ideal captured image data in a case where the defective pixel complementation is performed. Therefore, the performance of the defective pixel complementation algorithm can be improved by comparing the captured image data obtained by the defective pixel complementation algorithm with the estimated captured image data corresponding to the first captured image data, that is, the estimated ideal captured image data.

As described in the first embodiment, in the first imaging element 5, pixels having different color filters may be arranged in a predetermined pattern, and in the second imaging element 6, pixels having a plurality of light absorbing layers may be arranged, the plurality of light absorbing layers each absorbing light having different wavelength.

With this arrangement, for example, pixel signals of R, G, and B can be obtained for each pixel from the second imaging element 6. Therefore, demosaic processing is unnecessary in the second imaging element 6. Then, from the camera system 1, the first captured image data subjected to the demosaic processing and the second captured image data not subjected to the demosaic processing are output from the camera system.

Such a learning model obtained by performing machine learning using the first captured image data and the second captured image data is based on a difference between the first captured image data and the second captured image data. Therefore, it is possible to improve the complementation algorithm in the demosaic processing, perform correction for preventing deterioration of resolution due to the demosaic processing, and the like.

As described in the first embodiment, the second imaging element 6 may have higher frequency of occurrence of optical crosstalk and higher light receiving sensitivity than the first imaging element.

Specifically, the first imaging element 5 is an imaging element specialized for reducing optical crosstalk, and the second imaging element 6 is an imaging element specialized for improving light receiving sensitivity. As a result, it is possible to output the first captured image data in which optical crosstalk is reduced and the second captured image data in which light receiving sensitivity is high and an increase in noise due to gain control or the like is reduced.

By using a learning model obtained by performing machine learning using these pieces of captured image data as learning data, it is possible to estimate captured image data in which both noise due to optical crosstalk and noise due to low light receiving sensitivity are reduced.

As described in the first embodiment, the number of pixels of the first captured image data and the number of pixels of the second captured image data may be the same.

By matching the number of pixels of both pieces of captured image data, different data corresponding to each pixel can be obtained from the first captured image data and the second captured image data. For example, in the case of color image data and distance image data, the distance image data is generated so as to include distance information corresponding to each pixel in the color image data.

By constructing the learning model using such two types of image data as learning data, it is possible to improve the accuracy of inference of the learning model.

As described in the first embodiment, the number of pixels of the first captured image data may be larger than the number of pixels of the second captured image data.

For example, the first captured image data is high-resolution captured image data, and the second captured image data is low-resolution captured image data.

By constructing a learning model using such captured image data as learning data, it is possible to generate a learning model for inferring high-resolution captured image data from low-resolution captured image data.

Note that the effects described in the present specification are merely examples and are not limited, and other effects may be provided.

Furthermore, each example described above may be combined in any way, and the above-described various functions and effects may be obtained even in a case where various combinations are used.

### 7. Providing System

A providing system 100 that provides various types of information used for machine learning to a user who intends to obtain a learning model by performing machine learning will be described.

The providing system 100 is a system that provides various types of information to a user U.

The providing system 100 includes a server device 101 and a learning data acquisition device 102.

The server device 101 is a computer device that has a function as a data server performing management of learning data and the like and performs various types of processing in response to a request of the user U.

The server device 101 performs processing of accumulating learning data, search processing, acquisition processing, transmission processing, and the like.

Specifically, the server device 101 receives a transmission request of learning data from the user U, and searches for learning data matching the request of the user U from the learning data under management. In a case where the learning data according to the request of the user U is found, the learning data extracted as the search result is provided to the user U. Providing the learning data to the user U is realized, for example, by performing the transmission processing to the computer device used by the user U.

On the other hand, in a case where there is no appropriate learning data according to the request of the user U, or in a case where the amount of data desired by the user U is insufficient even if there is learning data, information such as conditions for acquiring learning data desired by the user U, that is, captured image data is transmitted to a sensor factory 200.

The information on the condition for acquiring the captured image data desired by the user U includes the number of pixels of the imaging element, information on the imaging optical system, the condition on the optical filter included in the imaging element, and the like.

Describing using a specific example, in a case where it is desired to construct a learning model for extracting distance information for each subject from color captured image data, information for manufacturing the camera system 1B according to the second embodiment described above capable of acquiring both the color captured image data and the distance image data is transmitted to the sensor factory 200. For these pieces of information, for example, conditions such as the number of pixels and an optical filter for creating the first imaging element 5, conditions such as the number of pixels and an optical filter for creating the second imaging element 6, moreover, information for preparing the light emitting unit 9 (information such as a light emission period, a light emission time, and a wavelength of light to be irradiated), information for preparing the IR cut filter 10, and the like are provided to the sensor factory 200.

In the sensor factory 200, an imaging element is created on the basis of the received information, and the camera system 1 for obtaining desired captured image data of the user U is manufactured and provided to the learning data acquisition device 102.

The learning data acquisition device 102 acquires captured image data, that is, captures the captured image data using the camera system 1. The acquired captured image data is accumulated as learning data by being transmitted to the server device 101.

The captured image data captured for the user U is transmitted as learning data from the server device 101 or directly from the learning data acquisition device 102 to the user U (the computer device used by the user U).

Note that the server device 101 may propose to provide additional learning data to the user U. The additional learning data includes learning data that can improve the performance of the learning model created by the user U.

For example, a set of various color image data and distance image data obtained by changing the number of pixels and imaging conditions is proposed as additional learning data.

Alternatively, a data set in which three or more types of captured image data are combined may be proposed as the additional learning data.

For example, in a case where the user U requests the learning data of the color captured image data and the distance image data, since the distance image data is data output from the imaging element as the ToF sensor, errors such as noise and jitter are included.

Even if machine learning is performed using learning data including such an error, there is a possibility that the performance of the learning model will be lowered.

Therefore, a data set in which color image data, distance image data, and polarized image data form a set is proposed as additional learning data.

By reducing the error included in the distance image data using the polarized image data, the accuracy of the distance image data can be improved, and the performance of the learning model to be created can be further improved.

In addition to this, in a case where learning data of low-resolution color image data and high-resolution color image data is requested, monochrome image data may be proposed as additional learning data.

An imaging element for obtaining high-resolution color image data generally has low light receiving sensitivity.

Therefore, by providing monochrome captured image data having the same number of pixels as the high-resolution color image data to the user U, it is possible to reduce an error (noise) of the high-resolution color image data and to generate a higher-performance learning model.

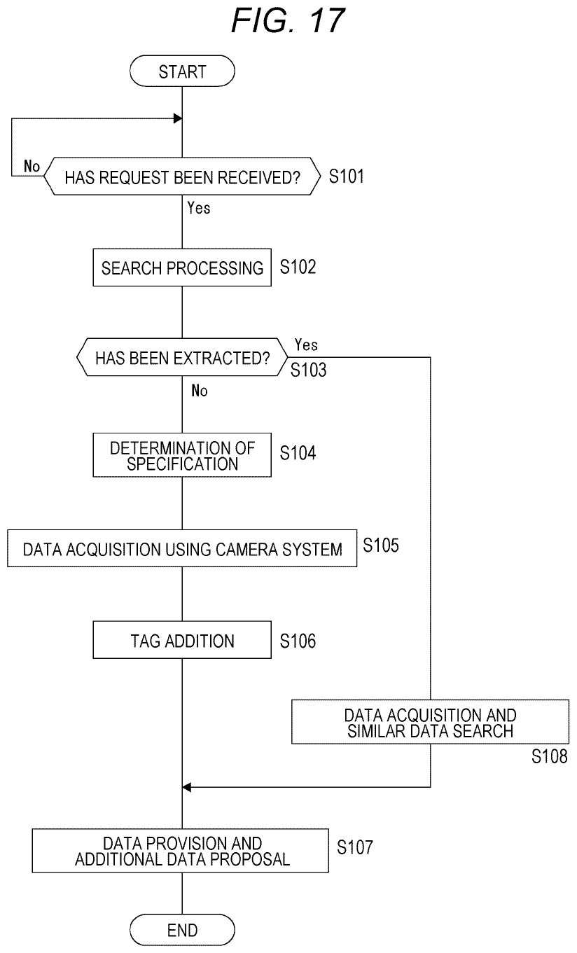

An example of a flow of processing executed by the providing system 100 will be described with reference to FIG. 17.

In step S101, the providing system 100 determines whether or not a request has been received from the user U. In a case where the request has not been received, the processing of step S101 is executed again.

In a case where it is determined that the request has been received from the user U, the providing system 100 sets a search condition according to the request of the user U and executes the search processing in step S102. By this processing, learning data that meets the condition desired by the user U is searched from the learning data managed by the providing system 100. This search processing is performed using a tag described later added to each piece of learning data.

In step S103, the providing system 100 determines whether or not the learning data has been extracted as a result of the search processing.

In a case where it is determined that the learning data has not been extracted, the process proceeds to a production process of the imaging element. Specifically, in step S104, the providing system 100 determines the specification of the imaging element and provides the specification to the sensor factory 200.

After the camera system 1 is manufactured in the sensor factory 200, the providing system 100 acquires learning data using the camera system 1 in step S105. Specifically, imaging is performed using the camera system 1, and for example, both color captured image data and distance image data are obtained.

In step S106, the providing system 100 adds tags to the acquired learning data. The tag to be added is used for the search processing, and is, for example, information for specifying that captured image data captured is color captured image data or distance image data, information on the number of pixels, or the like. Alternatively, information on the subject may be added as a tag.

Specifically, the tag is information on an imaging element, information on a subject, information on a condition for obtaining captured image data, information on an imaging condition, or the like.

The information on the imaging element may include product information, a type of the imaging element, an optical size, a pixel size, the number of pixels, setting information of the imaging element, and the like.

The information on the subject may include information such as a person, a landscape, a vehicle, and a face.

The information on the condition for obtaining the captured image data may include information such as average output and an exposure time.

The information on the imaging condition may include information on the imaging optical system, an exposure time, imaging time, position information, and the like. Moreover, information (emission wavelength) of the light emitting unit 9 and the like may be included.

In step S107, the providing system 100 provides data to the user U. Note that the providing system 100 may propose additional data in step S107.

In a case where it is determined in step S103 that the learning data desired by the user U has been extracted, the providing system 100 proceeds to step S108 and acquires the learning data.

Moreover, in step S107, the providing system 100 provides data to the user U.

Note that, in a case where the additional data is proposed, similar data may be searched in step S108, and the extracted learning data may be provided to the user U as the additional data in step S107. Alternatively, in step S108, the type of the captured image data contributing to the improvement of the performance of the learning model may be specified to perform the search processing, and the extracted captured image data may be provided to the user U in step S107 as the additional data.

Note that a means for acquiring the learning data may be provided instead of providing the learning data to the user U.

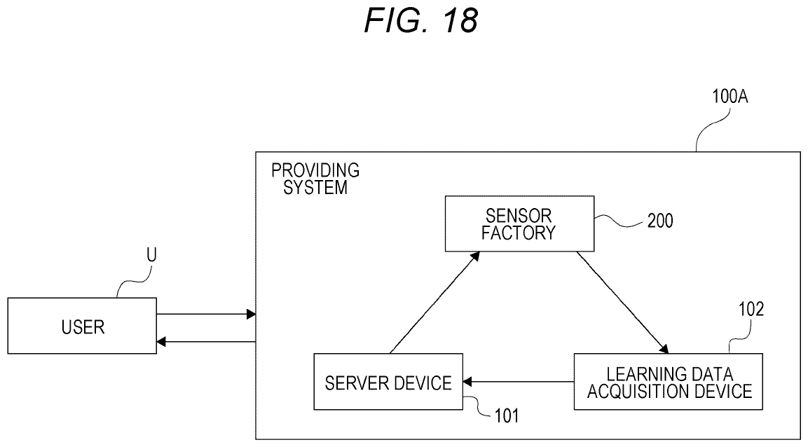

This will be specifically described with reference to FIG. 18.

A providing system 100A includes not only the server device 101 and the learning data acquisition device 102 but also the sensor factory 200.

The camera system 1 manufactured in the sensor factory 200 may be provided to the user U in addition to being used for learning data acquisition by the learning data acquisition device.

As a result, the user U can acquire the learning data by himself/herself using the camera system 1.

Furthermore, the sensor factory 200 may create imaging elements (the first imaging element 5 and the second imaging element 6) constituting the camera system 1 and provide the imaging elements to the user U. Alternatively, the second imaging element 6 may be created on the basis of the information of the first imaging element 5, which has been already possessed by the user U, and the second imaging element 6 may be provided to the user.

The user U creates the camera system 1 using the provided imaging element and acquires learning data.

As described above, in the providing system 100A, not only the data but also the created imaging element and the camera system 1 itself can be provided to the user U.

Note that, in a case where the user U acquires the learning data using the camera system 1, the learning data cannot be accumulated in the server device 101.

Therefore, the user U may be requested to upload the acquired learning data. Then, the providing system 100A may be configured to be able to provide additional learning data or pay money as an incentive.

In a case where the learning data acquired by the user U is provided, the learning data is accumulated in the server device 101.

### 8. Computer Device

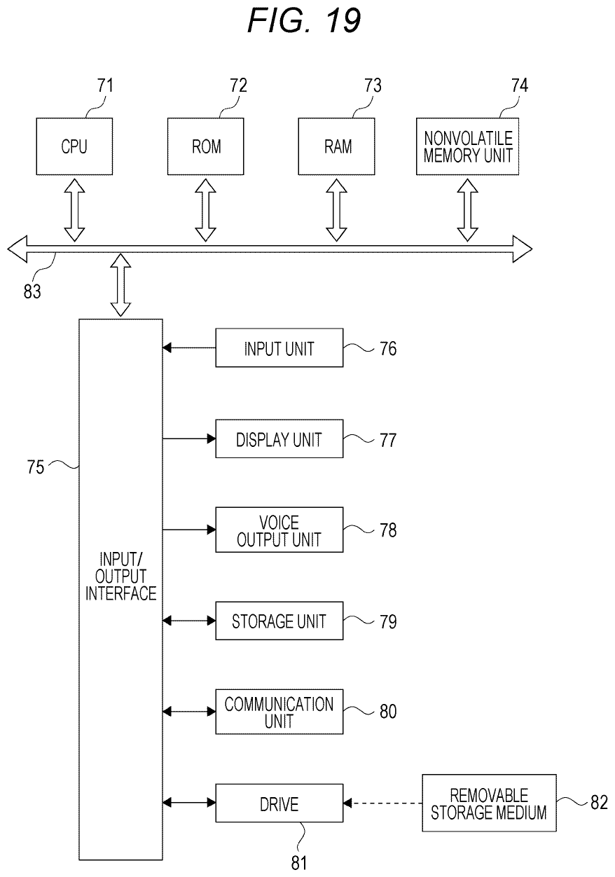

A configuration of a computer device included in the providing systems 100 and 100A will be described with reference to FIG. 19.

The computer device includes a CPU 71. The CPU 71 functions as an arithmetic processing unit that performs the above-described various type of processing, and executes various type of processing in accordance with a program stored in a nonvolatile memory unit 74 such as a ROM 72 or, for example, an electrically erasable programmable read-only memory (EEP-ROM), or a program loaded from a storage unit 79 to a RAM 73. Furthermore, the RAM 73 also appropriately stores data and the like necessary for the CPU 71 to execute the various types of processing.

Note that the CPU 71 included in the computer device as the providing system 100 executes each processing illustrated in FIG. 17 to implement each function described above.

The CPU 71, the ROM 72, the RAM 73, and the nonvolatile memory unit 74 are connected to one another via a bus 83. An input/output interface (I/F) 75 is also connected to the bus 83.

An input unit 76 including an operation element and an operation device is connected to the input/output interface 75. For example, as the input unit 76, various types of operation elements and operation devices such as a keyboard, a mouse, a key, a dial, a touch panel, a touch pad, a remote controller, and the like are assumed.

A user operation is detected by the input unit 76, and a signal corresponding to the input operation is interpreted by the CPU 71.

In addition, a display unit 77 including an LCD, an organic EL panel, or the like, and a voice output unit 78 including a speaker or the like are connected to the input/output interface 75 integrally or separately.

The display unit 77 is a display unit that performs various displays, and includes, for example, a display device provided in a housing of the computer device, a separate display device connected to the computer device, or the like.

The display unit 77 executes display of an image for various types of image processing, a moving image to be processed, and the like on a display screen on the basis of an instruction from the CPU 71. In addition, the display unit 77 displays various types of operation menus, icons, messages, and the like, that is, displays as a graphical user interface (GUI) on the basis of an instruction from the CPU 71.

In some cases, the storage unit 79 including a hard disk, a solid-state memory, or the like, and a communication unit 80 including a modem or the like are connected to the input/output interface 75.

The communication unit 80 performs communication processing via a transmission path such as the Internet, wired/wireless communication with various types of devices, bus communication, and the like.

A drive 81 is also connected to the input/output interface 75 as necessary, and a removable storage medium 82 such as a magnetic disk, an optical disk, a magneto-optical disk, or a semiconductor memory is appropriately mounted.

A data file such as a program used for each processing can be read from the removable storage medium 82 by the drive 81. The read data file is stored in the storage unit 79, and images and voice included in the data file are output by the display unit 77 and the voice output unit 78. Furthermore, a computer program and the like read from the removable storage medium 82 are installed in the storage unit 79 as necessary.

In this computer device, for example, software for processing of the present embodiment can be installed via network communication by the communication unit 80 or the removable storage medium 82. Alternatively, the software may be stored in advance in the ROM 72, the storage unit 79, or the like.

Information processing and communication processing necessary for the providing system 100, which is a computer device including the above-described arithmetic processing unit, are executed by the CPU 71 performing the processing operations on the basis of the various programs.

Note that the providing system 100 is not limited to be configured by a single computer device as illustrated in FIG. 19 and may be configured by systematizing a plurality of computer devices. The plurality of computer devices may be systematized by a local area network (LAN) or the like, or may be disposed in a remote place by a virtual private network (VPN) or the like using the Internet or the like. The plurality of computer devices may include a computer device as a server group (cloud) that can be used by a cloud computing service.

### 9. Summary of Providing System

The providing method executed by the providing system 100 (100A) described above is a method in which a computer device executes processing of receiving a request for providing learning data used for machine learning from a user (a request reception function of the server device 101) and processing of providing first captured image data and second captured image data captured by the camera system 1 (1A, 1A′, 1B, 1B′, 1C, 1C′, 1D, 1E) in response to the request (a data providing function of the server device 101). Then, a camera system 1 includes: an imaging optical system 2 including an optical element (a lens, an iris, or the like) for imaging; a mirror (a first mirror 3 such as a movable mirror 3A or a half mirror 3B) configured to perform spectroscopy on light (subject light) incident via the imaging optical system 2; a first imaging element 5 configured to output first captured image data used as learning data of machine learning by receiving incident light (subject light) incident via the mirror and performing photoelectric conversion; and a second imaging element 6 configured to output second captured image data used as the learning data by receiving incident light incident via the mirror and performing photoelectric conversion.

With this configuration, the first captured image data and the second captured image data obtained by the photoelectric conversion by the first imaging element 5 and the second imaging element 6 that receive light passing through the same imaging optical system 2 are provided to the user.

Therefore, since the difference in the imaging optical system can be eliminated from the factor of the difference between the first captured image data and the second captured image data, it is possible to provide appropriate learning data for estimating another captured image data from one captured image data. Then, by performing machine learning using these captured image data as the learning data, the user U can improve the accuracy of the learning model.

In particular, by making the imaging optical system 2 common between the first imaging element 5 and the second imaging element 6, various conditions regarding imaging as an angle of view, a distance to the subject, and an imaging direction can be perfectly matched between both imaging elements, which is preferable.

### 10. Present Technology

The present technology can also adopt the following configurations.

(1)

A camera system including:
an imaging optical system including an optical element for imaging;
a mirror configured to perform spectroscopy on light incident via the imaging optical system;
a first imaging element configured to output first captured image data used as learning data of machine learning by receiving incident light incident via the mirror and performing photoelectric conversion; and
a second imaging element configured to output second captured image data used as the learning data by receiving incident light incident via the mirror and performing photoelectric conversion.
   (2)

The camera system according to (1),
in which the spectroscopy is time-division spectroscopy.
   (3)

The camera system according to (2), further including
a mirror movable part configured to move the mirror between a first position in which reflected light on the mirror is guided to the first imaging element and a second position in which the reflected light is guided to the second imaging element.
   (4)

The camera system according to any one of (1) to (3),
in which the mirror is a half mirror,
the spectroscopy is simultaneous spectroscopy by the half mirror, and
reflected light on the half mirror is incident on one imaging element of the first imaging element and the second imaging element, and transmitted light on the half mirror is incident on another imaging element.
   (5)

The camera system according to any one of (1) to (5),
in which the first captured image data is color image data.
   (6)

The camera system according to (5),
in which the second captured image data is distance image data.
   (7)

The camera system according to (6), further including
a light emitting unit in which light emission is controlled in synchronization with an imaging operation of the second imaging element.
   (8)

The camera system according to (5),
in which the second captured image data is polarized image data.
   (9)

The camera system according to any one of (1) to (8),
in which an optical filter included in the first imaging element and an optical filter included in the second imaging element have different optical characteristics.
   (10)

The camera system according to (9),
in which the first imaging element includes a primary color filter, and
the second imaging element includes a complementary color filter.
   (11)

The camera system according to (5),
in which the second captured image data is monochrome image data.
   (12)

The camera system according to any one of (1) to (11),
in which the first imaging element has a pixel configuration not including a phase difference pixel, and
the second imaging element has a pixel configuration including a phase difference pixel.
   (13)

The camera system according to any one of (1) to (12),
in which in the first imaging element, pixels having different color filters are arranged in a predetermined pattern, and
in the second imaging element, pixels having a plurality of light absorbing layers are arranged, the plurality of light absorbing layers each absorbing light having different wavelength.
   (14)

The camera system according to any one of (1) to (13),
in which the second imaging element has higher frequency of occurrence of optical crosstalk and higher light receiving sensitivity than the first imaging element.
   (15)

The camera system according to any one of (1) to (14),
in which the number of pixels of the first captured image data and the number of pixels of the second captured image data are the same.
   (16)

The camera system according to any one of (1) to (15),
in which the number of pixels of the first captured image data is larger than the number of pixels of the second captured image data.

### REFERENCE SIGNS LIST

1, 1A, 1A′, 1B, 1B′, 1C, 1C′, 1D, 1E Camera system
2 Imaging optical system
3 First mirror (mirror)
3A Movable mirror (mirror)
3B Half mirror (mirror)
5 First imaging element
6 Second imaging element
7 Mirror movable part
9 Light emitting unit
P1 First position
P2 Second position

1. A camera system comprising:
an imaging optical system including an optical element for imaging;
a mirror configured to perform spectroscopy on light incident via the imaging optical system;
a first imaging element configured to output first captured image data used as learning data of machine learning by receiving incident light incident via the mirror and performing photoelectric conversion; and
a second imaging element configured to output second captured image data used as the learning data by receiving incident light incident via the mirror and performing photoelectric conversion.

2. The camera system according to claim 1,
wherein the spectroscopy is time-division spectroscopy.

3. The camera system according to claim 2, further comprising
a mirror movable part configured to move the mirror between a first position in which reflected light on the mirror is guided to the first imaging element and a second position in which the reflected light is guided to the second imaging element.

4. The camera system according to claim 1,
wherein the mirror is a half mirror,
the spectroscopy is simultaneous spectroscopy by the half mirror, and
reflected light on the half mirror is incident on one imaging element of the first imaging element and the second imaging element, and transmitted light on the half mirror is incident on another imaging element.

5. The camera system according to claim 1,
wherein the first captured image data is color image data.

6. The camera system according to claim 5,
wherein the second captured image data is distance image data.

7. The camera system according to claim 6, further comprising
a light emitting unit in which light emission is controlled in synchronization with an imaging operation of the second imaging element.

8. The camera system according to claim 5,
wherein the second captured image data is polarized image data.

9. The camera system according to claim 1,
wherein an optical filter included in the first imaging element and an optical filter included in the second imaging element have different optical characteristics.

10. The camera system according to claim 9,
wherein the first imaging element includes a primary color filter, and
the second imaging element includes a complementary color filter.

11. The camera system according to claim 5,
wherein the second captured image data is monochrome image data.

12. The camera system according to claim 1,
wherein the first imaging element has a pixel configuration not including a phase difference pixel, and
the second imaging element has a pixel configuration including a phase difference pixel.

13. The camera system according to claim 1,
wherein in the first imaging element, pixels having different color filters are arranged in a predetermined pattern, and
in the second imaging element, pixels having a plurality of light absorbing layers are arranged, the plurality of light absorbing layers each absorbing light having different wavelength.

14. The camera system according to claim 1,
wherein the second imaging element has higher frequency of occurrence of optical crosstalk and higher light receiving sensitivity than the first imaging element.

15. The camera system according to claim 1,
wherein the number of pixels of the first captured image data and the number of pixels of the second captured image data are the same.

16. The camera system according to claim 1,
wherein the number of pixels of the first captured image data is larger than the number of pixels of the second captured image data.
